(19) United States
(12) Patent Application Publication
(10) Pub. No.: US 2015/0085291 A1
(43) Pub. Date: Mar. 26, 2015

(54) Compact Self-Contained Holographic and Interferometric Apparatus

(71) Applicant: ASML Holding N.V., Veldhoven (NL)

(72) Inventors: Yuli Vladimirsky, Weston, CT (US); Lev Ryzhikov, Norwalk, CT (US)

(21) Appl. No.: 14/388,322

(22) PCT Filed: Jan. 31, 2013
(86) PCT No.: PCT/EP2013/051932

§ 371 Date: Sep. 26, 2014

Related U.S. Application Data
(60) Provisional application No. 61/617,348, filed on Mar. 29, 2012.

(51) Int. Cl. G01B 9/021; G03H 1/04; G03H 1/00; G01B 9/04

(52) U.S. Cl. CPC G01B 9/021; G01B 9/04; G03H 1/041; G03H 1/0005; G03H 2001/005
USPC 356/457; 359/30

(57) ABSTRACT

A compact, self-contained holographic and interferometric apparatus and methods for eliminating vibration, including methods for eliminating relative displacement and vibration errors present in object and reference beam paths, are disclosed. The self-contained apparatus (600) includes an illuminated object (302) that scatters light and an objective lens (304) to form an object beam (350). The self-contained apparatus also includes a reference beam forming lens group (308) that forms a reference beam (352) from a portion of the object beam that passes through a pupil plane (306) of the objective lens (304). The object beam and the reference beam are propagated along a shared optical path, which eliminates relative displacement and vibration errors. The self-contained apparatus includes an image plane (316) where the object beam and reference beam are recombined to create an interference pattern, which is detected and analyzed. Methods for eliminating the instability, using the self-contained apparatus, are disclosed.

### CROSS-REFERENCE TO RELATED APPLICATION

This application claims the benefit of U.S. provisional application 61/617,348 which was filed on 29 Mar. 2012, and which is incorporated herein in its entirety by reference.

### BACKGROUND

1. Field

The present invention relates to an inspection apparatus usable, for example, in the manufacture of devices by lithographic techniques.

2. Related Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning” direction) while synchronously scanning the substrate parallel or anti-parallel to this direction. It is also possible to transfer the pattern from the patterning device to the substrate by imprinting the pattern onto the substrate.

In order to monitor the lithographic process, parameters of the patterned substrate are measured. Parameters may include, for example, the overlay error between two layers formed in or on the patterned substrate and critical line width of developed photosensitive resist. This measurement may be performed on a product substrate and/or on a dedicated metrology target. There are various techniques for making measurements of the microscopic structures formed in lithographic processes, including the use of scanning electron microscopes and various specialized tools. Holography and interferometry are related techniques for making measurements of the microscopic structures. Any apparatus that utilizes holography or interferometry requires the use of a reference beam for interference with the object beam. In either technique, the light from a laser is split into two beams. One beam is for object illumination and the other is for reference beam formation. These two beams follow substantially different object and reference beam paths.

One disadvantage of previous holographic and interferometric approaches is that the object beam path and the reference beam path are substantially different, requiring very high dimensional and mechanical stability. Vibrations are not fully eliminated through the use of tables, benches, and other isolation configurations. This often creates serious obstacles in generating quality holograms, especially in microscopic settings. Another way for holographic assemblies to reduce the effects of vibration has been to partially combine the optical and reference beam paths. However, a disadvantage to this approach is that significantly long segments of the optical beam path and the reference beam path remain independent from one another, rendering it incapable of eliminating the vibration problem.

### SUMMARY

Accordingly, there is a need for improved holographic and interferometric inspection apparatuses.

In one embodiment, a method of eliminating vibration and dimensional instability includes illuminating an object with a light beam and forming an object beam using an objective lens that is configured to direct the object beam through a tube lens onto an image plane. A reference beam is formed from a portion of the object beam passing through a pupil plane of the objective lens, using a reference beam lens group that is configured to propagate the reference beam along a shared optical path with the object beam. The method further includes combining the reference beam and the object beam to create an interference pattern at the image plane.

In another embodiment, an inspection apparatus includes a light source configured to produce a light beam, an objective lens configured to direct an object beam from an object illuminated by the light beam, and a reference beam lens group. The reference beam lens group is configured to form a reference beam from a portion of the object beam passing through a pupil plane of the objective lens, the reference beam being propagated along a shared optical path with the object beam. The inspection apparatus further includes a tube lens configured to direct the object beam and the reference beam onto an image plane. In addition, a processor is configured to determine an interference pattern on the image plane from the object beam and the reference beam.

In another embodiment, a method within an optical system includes illuminating an object with a light beam, forming an object beam using a microscope lens arrangement that is configured to direct the object beam through a tube lens onto an image plane along a main axis of the optical system, and forming a reference beam. The reference beam is formed using a reference beam lens group that is positioned at a central portion of a pupil plane of the microscope lens arrangement along the main axis of the optical system, wherein the reference beam is formed from a portion of the object beam passing through the pupil plane of the microscope lens arrangement. The method further includes propagating the reference beam along a shared optical path with the object beam, shifting a phase of the reference beam using a phase plate, and combining the reference beam and the object beam to create an interference pattern at the image plane.

In another embodiment, a method for microscopy includes propagating an object beam along an optical path and a longitudinal axis of an optical arrangement, the object beam formed from light scattered by an illuminated object. A reference beam is also propagated along the optical path substantially simultaneously with the object beam, the reference beam being formed from a portion of the light scattered by the illuminated object. The reference beam and the object beam interfere at an image plane to create a hologram image.

In another embodiment, a method for microscopy includes providing a first optical arrangement having a longitudinal axis to propagate an object beam in an optical path along the longitudinal axis, the object beam being formed from the light scattered by an illuminated object. A second optical arrangement is integrated with the first optical arrangement to propagate a reference beam substantially simultaneously with the object beam in the object path along the longitudinal axis, the reference beam being formed from a portion of the light scattered by the illuminated object. The reference beam causes interference with the object beam at an image plane.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a lithographic apparatus.

FIG. 2 depicts a lithographic cell or cluster.

FIG. 3 illustrates an optical schematic of an interferometric/holographic apparatus according to an embodiment that utilizes a spherical wave reference beam.

FIG. 4 illustrates an optical schematic of an interferometric/holographic apparatus according to another embodiment that utilizes a plane wave reference beam.

FIG. 5 illustrates an optical schematic of an interferometric/holographic apparatus according to another embodiment that utilizes a plane wave reference beam in a de-magnification configuration.

FIG. 6 depicts an optical schematic of the interferometric/holographic apparatus of FIG. 3.

FIG. 7 depicts an optical schematic of the interferometric/holographic apparatus of FIG. 4.

FIG. 8 depicts an optical schematic of an interferometric/holographic apparatus according to another embodiment that utilizes a pixelated phase mask dynamic interferometer.

FIG. 9 depicts an optical schematic of an interferometric/holographic apparatus according to another embodiment that utilizes heterodyne interferometry/holography.

FIG. 10 illustrates computer system hardware useful in implementing the embodiments shown in FIGS. 3 through 9.

FIG. 11 is a flow diagram of a method of sharing an optical path to eliminate errors due to vibration.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the present invention. The scope of the present invention is not limited to the disclosed embodiment(s). The present invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Before describing such embodiments in more detail, however, it is instructive to present an example environment in which embodiments of the present invention may be implemented.

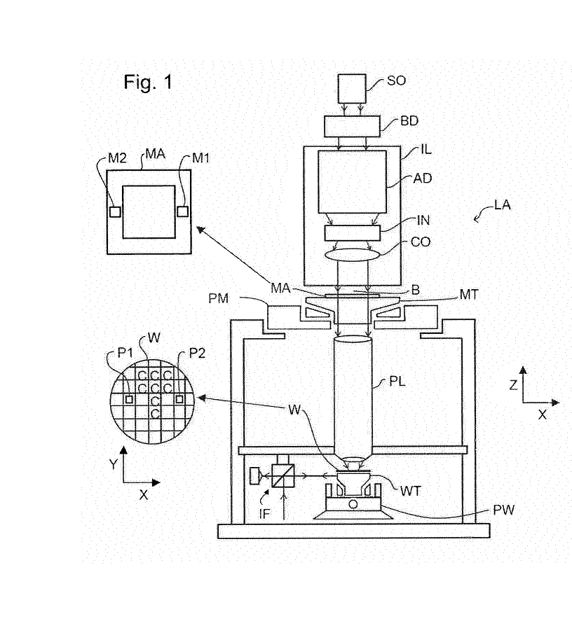

FIG. 1 schematically depicts a lithographic apparatus. The apparatus comprises an illumination system (illuminator) IL configured to condition a radiation beam B (e.g., UV radiation or DUV radiation), a support structure (e.g., a mask table) MT constructed to support a patterning device (e.g., a mask) MA and connected to a first positioner PM configured to accurately position the patterning device in accordance with certain parameters, a substrate table (e.g., a wafer table) WT constructed to hold a substrate (e.g., a resist-coated wafer) W and connected to a second positioner PW configured to accurately position the substrate in accordance with certain parameters, and a projection system (e.g., a refractive projection lens system) PL configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e., bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system.”

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring again to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g., an interferometric device, linear encoder, 2-D encoder or capacitive sensor), the substrate table WT can be moved accurately, e.g., so as to position different target portions C in the path of the radiation beam B. Similarly, the first positioner PM and another position sensor (which is not explicitly depicted in FIG. 1) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:
1. In step mode, the mask table MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed. In step mode, the maximum size of the exposure field limits the size of the target portion C imaged in a single static exposure.
2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.
3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

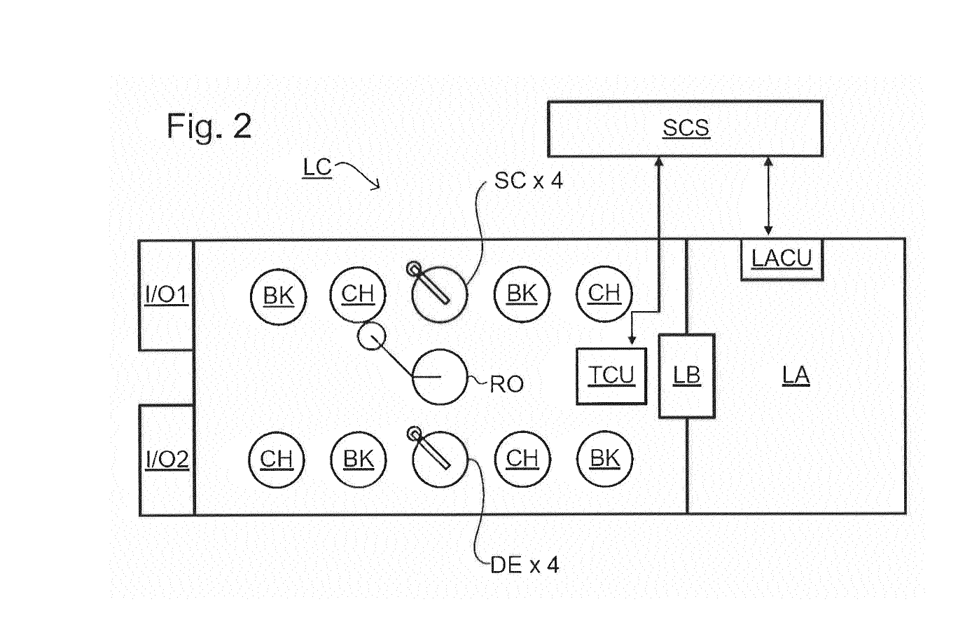

As shown in FIG. 2, the lithographic apparatus LA forms part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O1, I/O2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithography control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between two layers, line thicknesses, critical dimensions (CD), etc. If errors are detected, adjustments may be made to exposures of subsequent substrates, especially if the inspection can be done soon and fast enough that other substrates of the same batch are still to be exposed. Also, already exposed substrates may be stripped and reworked—to improve yield—or discarded, thereby avoiding performing exposures on substrates that are known to be faulty. In a case where only some target portions of a substrate are faulty, further exposures can be performed only on those target portions which are good.

An inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device.

Embodiments of the present invention may be used with or independently of scatterometers, or in combination with other tools as part of an in situ reticle inspection system, or other types of systems. For example, embodiments of the present invention may be included with microscope systems, such as electron microscopes, as an inexpensive attachment to the microscope objective. Such systems may include a broadband (white light) radiation projector which projects the radiation to an object under inspection. In such configurations, embodiments of the present invention would be located external to the main lens of the microscope system. The discussion that follows details different potential embodiments that may be applied in these different types of systems.

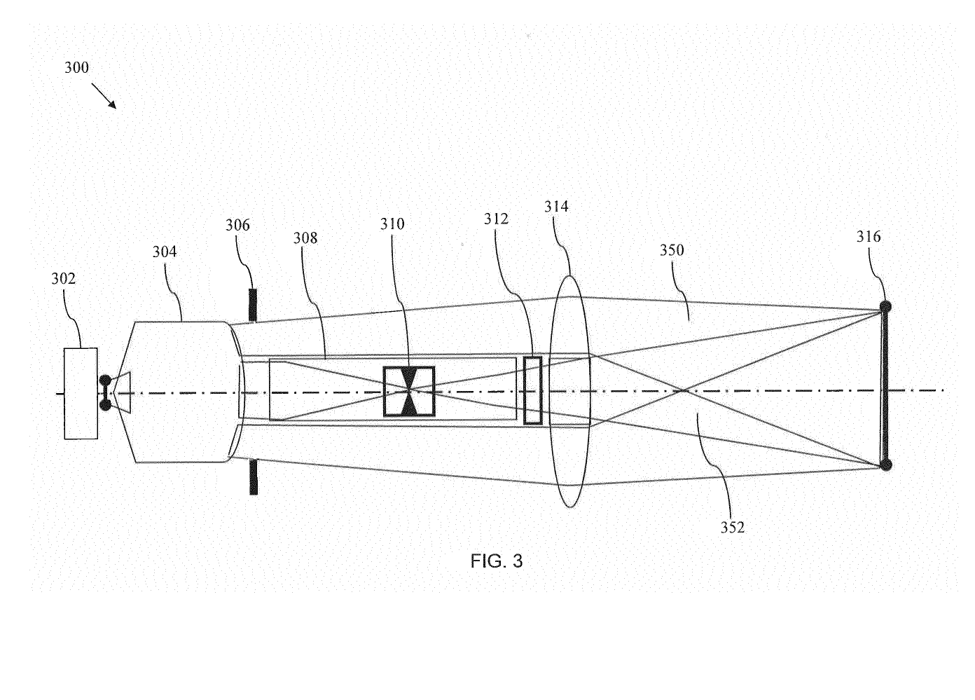

FIG. 3 illustrates an optical schematic of an apparatus 300 according to an embodiment that utilizes a spherical wave reference beam. Apparatus 300 can be an interferometric or holographic measurement device. For brevity, the following discussion will reference a holographic measurement device, though the skilled artisan will appreciate that the discussion will equally apply to an interferometric measurement device. Holographic measurement device 300 can sense one or more properties, such as defects in a patterning device (e.g., mask MA) before patterning. Such defects may be inherent in the patterning device or introduced externally by, for example, particles deposited on the patterning device. In one embodiment, holographic measurement device 500 operates in a wide spectral range from about 200 nm to about 850 nm.

Holographic measurement device 300 operates by utilizing the light scattered by an illuminated object 302 to form a reference beam. Illuminated object 302 may be a patterning device (e.g., mask MA) or any other object subject to inspection by a microscope, of which the holographic measurement device 300 may be a part. The light propagating through a central part of the pupil of an imaging lens 304 is used for forming the reference beam. For example, 0^{th} order light propagating through a central part of pupil plane 306 of imaging lens 304 is used. This is possible because the optical information of the object 302 under investigation, especially the optical information associated with fine and mid-sized features of the object 302, is concentrated in the outer part of the pupil plane 306 of imaging lens 304.

Holographic measurement device 300 also includes a reference beam forming lens group 308, a spatial filter 310, a phase plate 312, tube lens 314, and image plane 316. As indicated above, the central part of the pupil optical field of imaging lens 304 is used for reference beam formation. The reference beam forming lens group 308 intercepts a central part of the light scattered by the illuminated object 302, e.g. near an optical axis of the light path, and spatially filters, if desired, the intercepted light along with the spatial filter 310 to form reference beam 352. Spatial filter 310 is useful to remove from the reference beam any structure of the object beam that may have been intercepted from the central part of the light scattered by the illuminated object 302, such as rings and side lobes of the light. Spatial filter 310 may be a set of lenses with a pinhole, or may be implemented in other configurations as would be recognized by the skilled artisan. The spatial filter 310 may be positioned such that it is located at a waist of the reference beam 352. The remaining light scattered by the illuminated object 302 from the outer part of the pupil plane 306 constitutes an object beam 350.

Both beams—object beam 350 and reference beam 352—propagate along the main axis of the holographic measurement device 300 through the tube lens 314. In this manner, relative displacement or vibration of the object beam 350 and reference beam 352 are eliminated because each beam traverses a shared optical path. The phase plate 312 changes the phase of the reference beam 352 to enable the creation of holograms at the image plane 316, when the reference beam 352 is recombined with the object beam 350. The phase plate 312 may be situated, with reference to the direction of propagation of the object beam 350 and reference beam 352, before or after the tube lens 314, depending on the particular configuration of the reference beam forming lens group 308, as will be discussed in more detail below.

The optical configuration of holographic measurement device 300 is such that the reference beam 352 is divergent as it passes through the tube lens 314, resulting in a divergent spherical wave pattern on the image plane 316. The tube lens 314 further directs the object beam 350 onto the image 316, where the beams combine to form an interference pattern. This interference pattern may be recorded at the image plane 316 using a detector, e.g. a CCD, or any other suitable imaging device. The recorded pattern may then be reconstructed using a processor, which is not shown in FIG. 3.

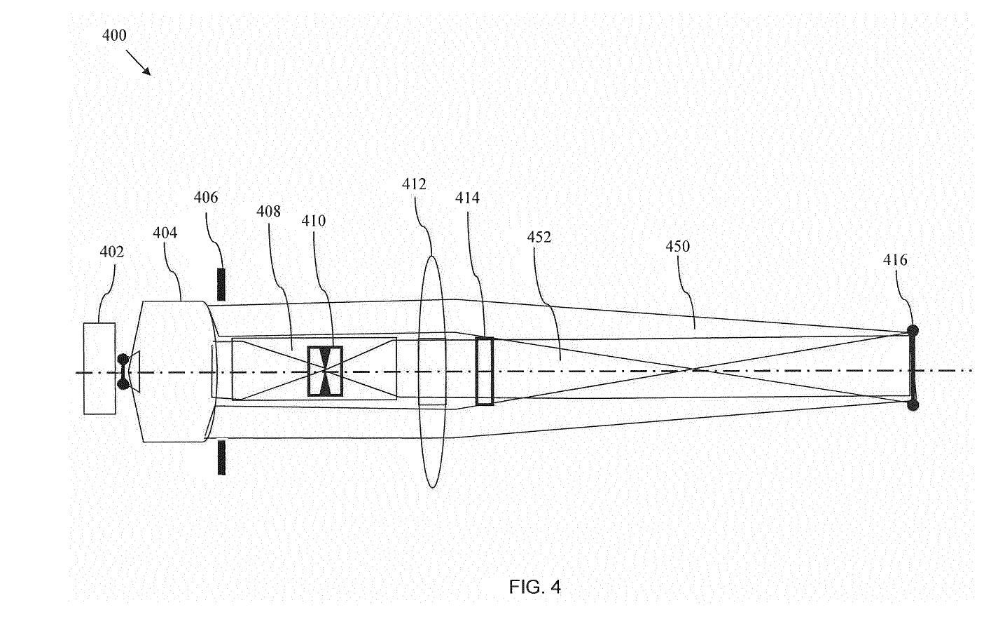

FIG. 4 illustrates another optical schematic of a holographic measurement device 400 according to another embodiment that utilizes a plane wave reference beam. Holographic measurement device 400 is similar in configuration and operation as device 300 above. Like device 300, holographic measurement device 400 operates by utilizing the light scattered by an illuminated object 402 to form a reference beam. Illuminated object 402 may be a patterning device (e.g., mask MA) or any other object subject to inspection by a microscope, of which the holographic measurement device 400 may be a part. The light propagating through a central part of the pupil of an imaging lens 404 is used for forming the reference beam. For example, 0^{th} order light propagating through a central part of pupil plane 406 of imaging lens 404 is used.

Holographic measurement device 400 also includes a reference beam forming lens group 408, a spatial filter 410, a tube lens 412, a phase plate 414, and an image plane 416. The central part of the pupil optical field of imaging lens 404 is used for reference beam formation. The reference beam forming lens group 408 intercepts a central part of the light scattered by the illuminated object 402, e.g. near an optical axis of the light path, and spatially filters, if desired, the intercepted light along with the spatial filter 410 to form reference beam 452. The remaining light scattered by the illuminated object 402 from the outer part of the pupil plane 406 constitutes an object beam 450.

Both beams—object beam 450 and reference beam 452—propagate along the main axis of the holographic measurement device 400 through the tube lens 412. In this manner, relative displacement or vibration of the object beam 450 and reference beam 452 are eliminated because each beam traverses a shared optical path. The phase plate 414 changes the phase of the reference beam 452 to enable the creation of holograms at the image plane 416, when the reference beam 452 is recombined with the object beam 450. The phase plate 414 may be situated, with reference to the direction of propagation of the object beam 450 and reference beam 452, before or after the tube lens 412, depending on the particular configuration of the reference beam forming lens group 408, for example after the tube lens 412 as depicted in FIG. 4.

The optical configuration of holographic measurement device 400 is such that the reference beam 452 is convergent as it passes through the tube lens 412, resulting in a convergent plane wave pattern on the image plane 416. The tube lens 412 further directs the object beam 450 onto the image plane 416, where the beams combine to form an interference pattern. This interference pattern may be recorded at the image plane 416 using a detector, e.g. a CCD, or any other suitable imaging device. The recorded pattern may then be reconstructed using a processor, which is not shown in FIG. 4.

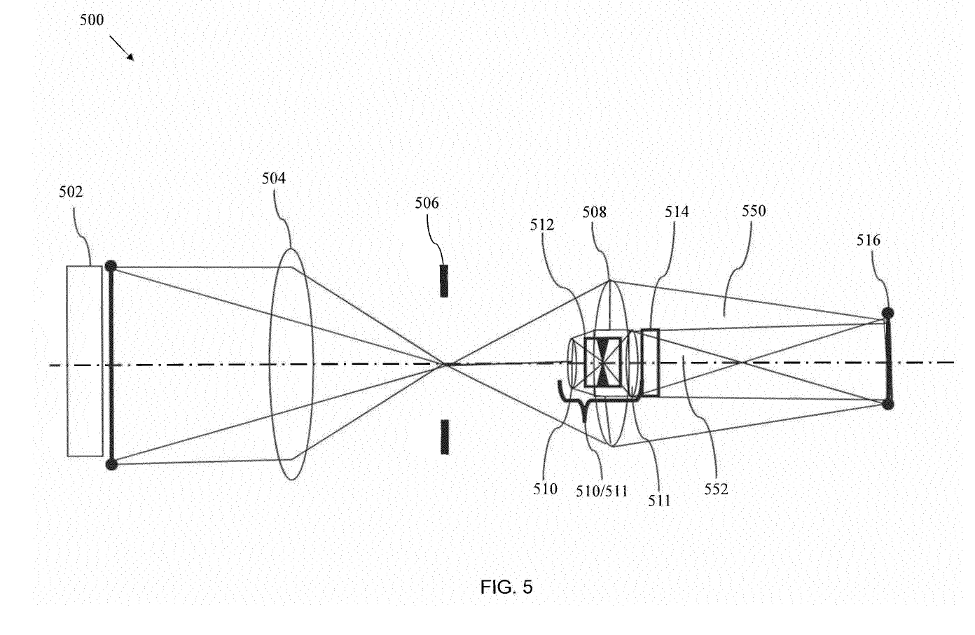

Embodiments of the present invention may also be applied in de-magnification schemes. FIG. 5 illustrates another optical schematic of a holographic measurement device 500 according to another embodiment that utilizes a plane wave reference beam in a de-magnification configuration. Holographic measurement device 500 operates by utilizing the light scattered by an illuminated object 502 to form a reference beam. Illuminated object 502 may be a patterning device (e.g., mask MA) or any other object subject to inspection by a microscope, of which the holographic measurement device 500 may be a part. The scattered light propagates through an object lens 504.

After passing a pupil plane 506, the scattered light is incident upon an imaging lens 508. A reference beam forming lens group 510/511 is situated at a central part of the imaging lens 508, where it directs a central part of the light propagating along the optical axis of the holographic measurement device 500 to form a reference beam 552. For example, 0^{th} order light propagating through a central part of imaging lens 508 is used. The reference beam forming lens group may include lenses 510 and 511, with a spatial filter 512, if desired, situated between the lenses 710 and 711. A phase plate 514 may be located after imaging lens 508 and reference beam forming lens group 510/511. The remaining light from the outer part of the pupil plane of imaging lens 508 scattered by the illuminated object 502 constitutes an object beam 550.

Both beams—object beam 550 and reference beam 552—propagate along the main axis of the holographic measurement device 500. In this manner, relative displacement or vibration of the object beam 550 and reference beam 552 are eliminated because each beam traverses a shared optical path. The phase plate 514 changes the phase of the reference beam 552 to enable the creation of holograms at an image plane 516, when the reference beam 552 is recombined with the object beam 550. The phase plate 514 may be situated, with reference to the direction of propagation of the object beam 550 and reference beam 552, before or after the imaging lens 708. The location of phase plate 514 depends on the particular configuration of the reference beam forming lens group 510/511, for example after the imaging lens 508 as depicted in FIG. 5.

The optical configuration of holographic measurement device 500 is such that the reference beam 552 is convergent after it is formed in the reference beam forming lens group 510/511, resulting in a convergent plane wave pattern on the image plane 516. The imaging lens 508 forms and directs the object beam 550 onto the image plane 516, where the beams combine to form an interference pattern. This interference pattern may be recorded at the image plane 516 using a detector, e.g. a CCD, or any other suitable imaging device. The recorded pattern may then be reconstructed using a processor, which is not shown in FIG. 5.

### Example Embodiments of a Holographic or Interferometric Measurement Device

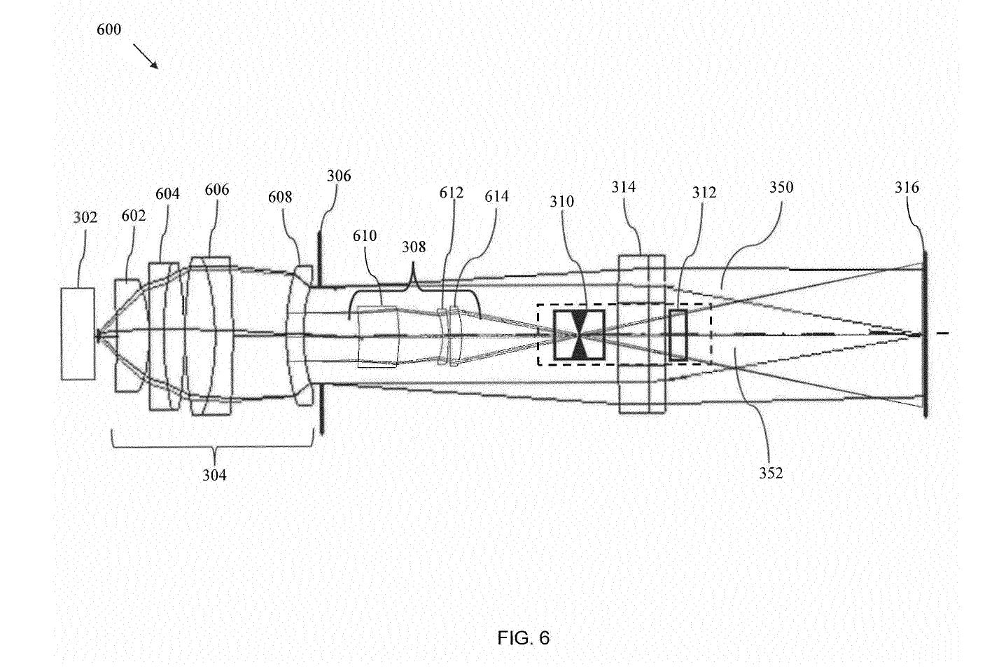

FIG. 6 depicts an optical schematic of the holographic measurement device of FIG. 3. Holographic measurement device 600, just as device 300 in FIG. 3, is a homodyne phase-step holographic arrangement with a spherical wave reference beam. Holographic measurement device 600 operates as indicated above in FIG. 3. Because relative displacement or vibration between the object beam and reference beam is eliminated by utilizing a shared optical path, the required temporal coherence of the light upon an object is significantly relaxed. This applies to the other embodiments as well as the present embodiment. In one embodiment, holographic measurement device 800 operates in a wide spectral range from about 200 nm to about 850 nm.

The imaging lens 304 of holographic measurement device 600 is depicted in greater detail, including four doublet lenses 602, 604, 606, and 608, for example. As will be understood by the skilled artisan, more or fewer lenses, and of other types, may be used to similar effect. In this embodiment, 0^{th} order light propagating through a central part of pupil plane 306 of imaging lens 304 is used. This is possible because the optical information of the object 302 under investigation, especially the optical information associated with fine and mid-sized features of the object 302, is concentrated in the outer part of the pupil plane 306 of imaging lens 304.

Reference beam forming lens group 308 may include lenses 610, 612, and 614. As will be recognized by the skilled artisan, more or fewer lenses, and of other types, may be used to similar effect. These lenses operate together to intercept a central part of the light scattered by the illuminated object 302. In this embodiment, the lenses 610, 612, and 614 that comprise the reference beam forming lens group 308 are all located before the tube lens 314. By situating the reference beam forming lens group lenses in this manner, the reference beam 352 is divergent as it passes through the tube lens 314.

The phase plate 312 may include a set of three or more phase plates (not shown) to cover a 2π phase range, as required for homodyne holography. In this embodiment, phase plate 312 is situated, with reference to the direction of propagation of the object beam 350 and reference beam 352, after the tube lens 314. As indicated above, the object beam 350 and reference beam 352 propagate along a shared optical path, in this example along a central axis of the holographic measurement device 600, which eliminates relative displacement and/or vibration of the object beam 350 and reference beam 352. This results in a divergent spherical wave pattern on the image plane 316 that has been phase-shifted. The object beam 350 combines with the reference beam 352 on the image plane 316 to form the interference pattern, which is processed as indicated above with reference to FIG. 3.

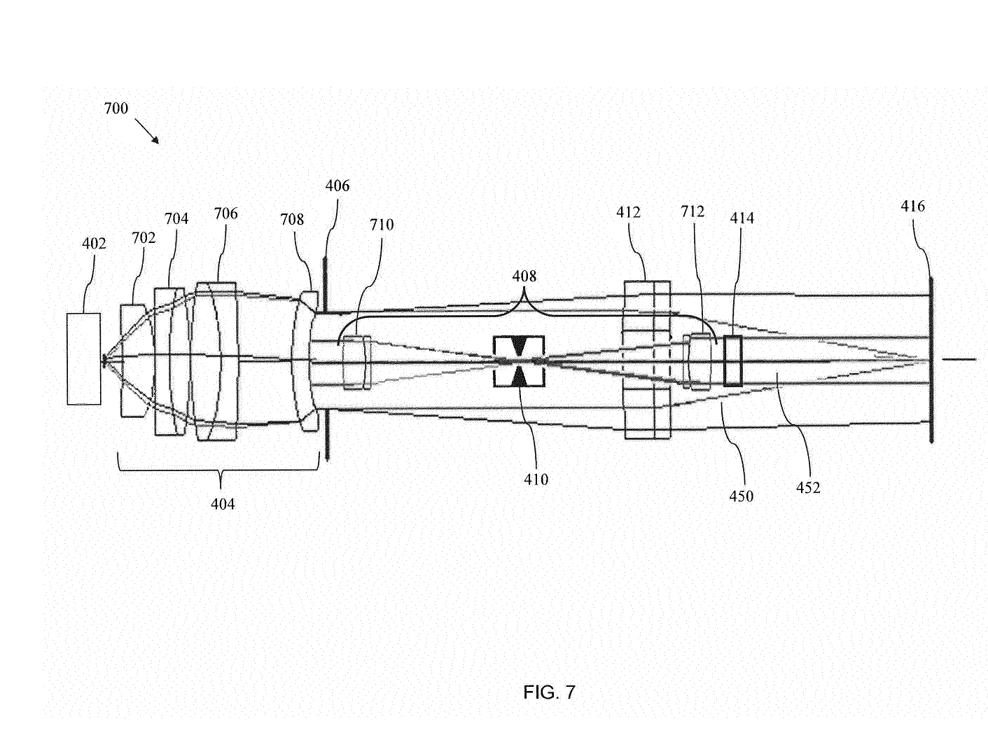

FIG. 7 depicts an optical schematic of the holographic measurement device of FIG. 4. Holographic measurement device 700, just as device 400 in FIG. 4, is a homodyne phase-step holographic arrangement with a plane wave reference beam. In addition to the elements introduced in FIG. 4 and discussed above, the imaging lens 404 of holographic measurement device 700 includes four doublet lenses 702, 704, 706, and 708, for example. As will be understood by the skilled artisan, more or fewer lenses, and of other types, may be used to similar effect. In this embodiment, 0^{th} order light propagating through a central part of pupil plane 406 of imaging lens 404 is used. This is possible because the optical information of the object 402 under investigation, especially the optical information associated with fine and mid-sized features of the object 402, is concentrated in the outer part of the pupil plane 406 of imaging lens 404.

Reference beam forming lens group 408 includes lenses 710 and 712. These lenses operate together to intercept a central part of the light scattered by the illuminated object 402. As will be understood by the skilled artisan, more or fewer lenses, and of other types, may be used to similar effect. In this embodiment, the lenses 710 and 712 that comprise the reference beam forming lens group 408 are located, respectively, before and after the tube lens 412. For example, lens 710 may be situated after the imaging lens 404 but before the spatial filter 410 and tube lens 412, as depicted in FIG. 7. Lens 712 may be situated after tube lens 412. By situating the reference beam forming lens group lenses 710 and 712 in this manner, the reference beam 452 is convergent as it is incident upon the imaging plane 416.

As indicated above, the phase plate 414 may include three or more phase plates (not shown) to cover a 2π phase range, as required for homodyne holography. In this embodiment, phase plate 414 is situated, with reference to the direction of propagation of the object beam 450 and reference beam 452, after the tube lens 412. As indicated above, the object beam 450 and reference beam 452 propagate along a shared optical path, in this example along a central axis of the holographic measurement device 700, which eliminates relative displacement and/or vibration of the object beam 450 and reference beam 452. This results in a convergent plane wave pattern on the image plane 416 that has been phase-shifted. The object beam 450 combines with the reference beam 452 on the image plane 416 to form the interference pattern, which is processed as indicated above with reference to FIG. 4.

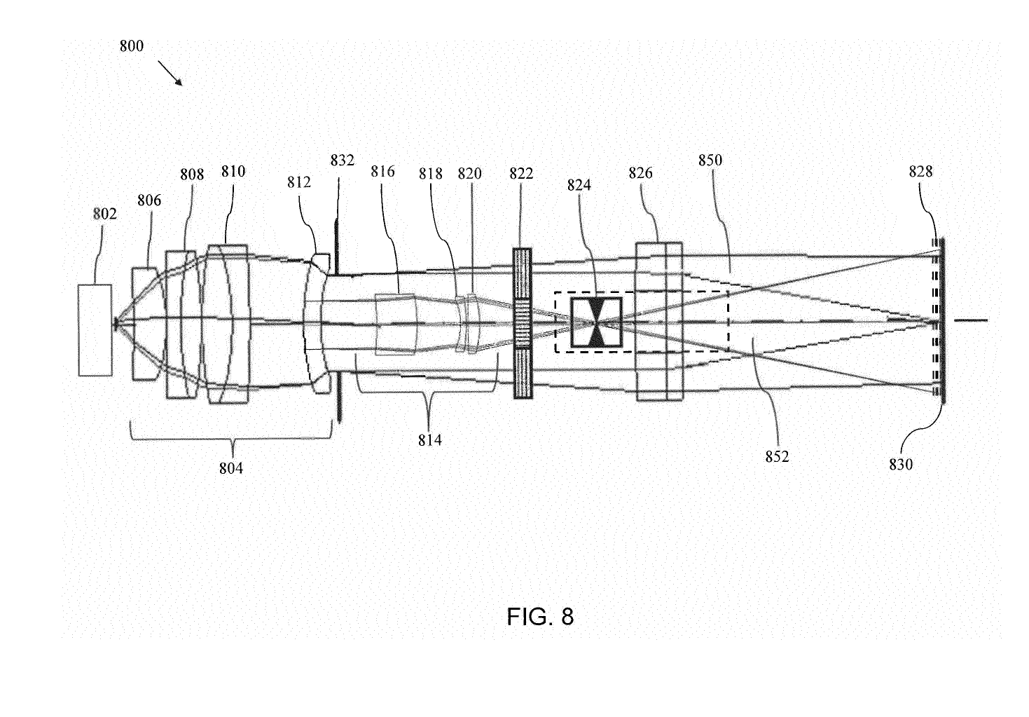

FIG. 8 depicts an optical schematic of holographic measurement device 800 according to another embodiment that utilizes a pixelated phase mask dynamic interferometer. Holographic measurement device 800 can sense one or more properties, such as defects in a patterning device (e.g., mask MA) before patterning. These defects could be inherent in the patterning device or introduced externally by, for example, particles deposited on the patterning device. In one embodiment, holographic measurement device 800 operates in a wide spectral range from about 200 nm to about 850 nm.

Holographic measurement device 800 operates by utilizing the light scattered by an illuminated object 802 to form a reference beam. Illuminated object 802 may be a patterning device (e.g., mask MA) or any other object subject to inspection by a microscope, of which the holographic measurement device 800 may be a part. The light propagating through a central part of the pupil of an imaging lens 804 is used for forming the reference beam. Imaging lens 804 may include four doublet lenses 806, 808, 810, and 812, for example. As will be understood by the skilled artisan, more or fewer lenses, and of other types, may be used to similar effect. For example, 0^{th} order light propagating through a central part of a pupil plane 832 of imaging lens 804 is used. This is possible because the optical information of the object 802 under investigation, especially the optical information associated with fine and mid-sized features of the object 802, is concentrated in the outer part of the pupil plane 832 of imaging lens 804.

Holographic measurement device 800 may also include a reference beam forming lens group 814. For example, in this embodiment the reference beam forming lens group 814 includes lenses 816, 818, and 820, all of which are situated before the tube lens 826. As will be understood by the skilled artisan, more or fewer lenses, and of other types, may be used to similar effect. Holographic measurement device 800 may also include a circular polarizer 822 that circularly polarizes both the object beam 850 and reference beam 852. The circular polarizer 822 polarizes one beam to left-handed circularly polarized light and the other beam to right-handed circularly polarized light. Thus, for example, the circular polarizer 822 may be configured to polarize the object beam 850 to become left-handed circularly polarized light and the reference beam 852 to become right-handed circularly polarized light. Or, in the alternative, the object beam 850 becomes right-handed circularly polarized light, and the reference beam 852 becomes left-handed circularly polarized light. The object beam 850 and reference beam 852 thus obtain orthogonal circular polarizations to each other. A processor that reconstructs the interference pattern recorded at an image plane 830 may be programmed with the particular configuration of the circular polarizer 822 to establish which beam has which polarization.

Holographic measurement device 800 may also include a spatial filter 824, tube lens 826, and a pixelated phase mask 828. As indicated above, the central part of the pupil optical field of imaging lens 804 is used for reference beam formation. The reference beam forming lens group 814 intercepts a central part of the light scattered by the illuminated object 802, e.g. near an optical axis of the light path, and spatially filters, if desired, the intercepted light with the spatial filter 824 to form the reference beam 852. The spatial filter 824 is useful to remove from the reference beam 852 any structure of the object beam 850 that may have been intercepted from the central part of the light scattered by the illuminated object 802, such as rings and side lobes. The spatial filter 824 may be a set of lenses with a pinhole, for example, but other implementations will become apparent to the skilled artisan. The remaining light scattered by the illuminated object 802 from the outer part of the pupil plane 832 constitutes the object beam 850.

Both beams—object beam 850 and reference beam 852—propagate along the main axis of the holographic measurement device 800 through the tube lens 826. In this manner, relative displacement or vibration of the object beam and reference beam are eliminated because each beam traverses a shared optical path. In this embodiment, no phase plate is necessary because of the orthogonal circular polarization of the beams 850 and 854, and the pixelated phase mask 828. The pixelated phase mask 828 may include a CCD array, where each pixel of the CCD array has its own phase plate. Thus, each pixel has an image with a different phase. In addition, each pixel may have a separate lens. The pixelated phase mask 828 may have pixels arranged in groups of 4, for example, where each pixel in the group of 4 has a phase mask with a different phase shift. This pattern may then be repeated across the entirety of the CCD array.

The situation of the lenses 816, 818, and 820 in reference beam forming lens group 814 before the tube lens 826 results in a divergent spherical wave pattern as the reference beam 852 passes through the tube lens 826. The lenses in the reference beam forming lens group 814 could also be placed to impart a convergent plane wave pattern to the reference beam 852. Either configuration is possible for this embodiment. The tube lens 826 further directs the object beam 850 onto the pixelated phase mask 828, where the object and reference beams combine to form an interference pattern. This interference pattern may be recorded at the image plane 830. The recorded pattern may then be reconstructed using a processor, which is not shown in FIG. 8.

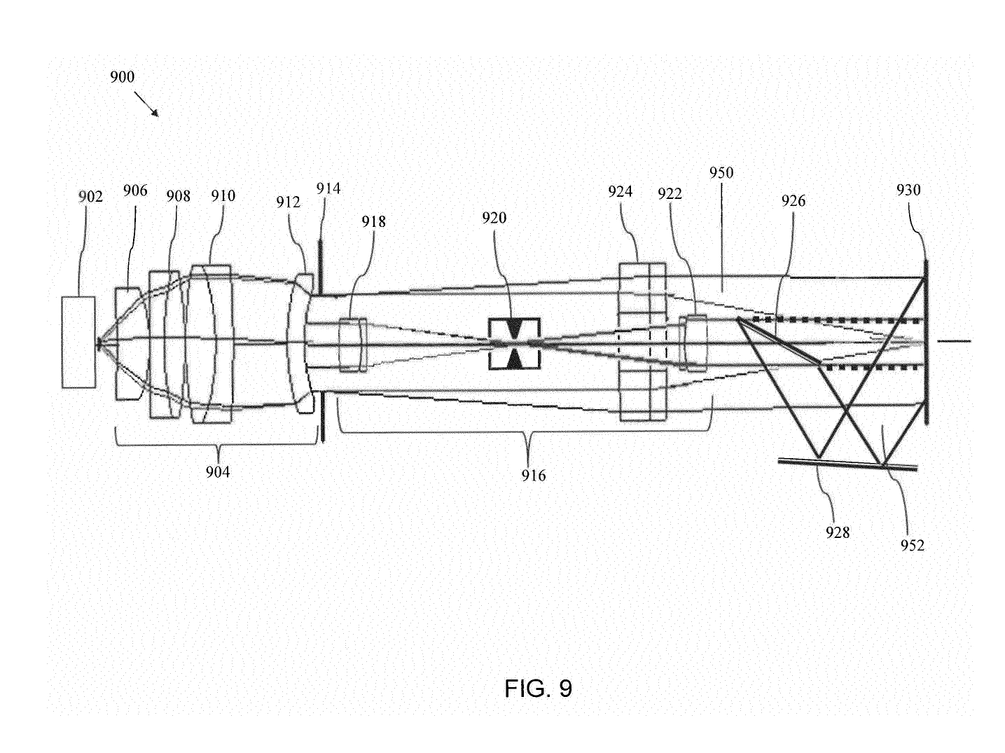

FIG. 9 depicts an optical schematic of a holographic measurement device 900 according to another embodiment that utilizes heterodyne interferometry or holography. Like the other embodiments discussed above, holographic measurement device 900 can sense one or more properties, such as defects in a patterning device (e.g., mask MA) before patterning. These defects could be inherent in the patterning device or introduced externally by, for example, particles deposited on the patterning device. In one embodiment, holographic measurement device 900 operates in a wide spectral range from about 200 nm to about 850 nm.

Holographic measurement device 900 operates by utilizing the light scattered by an illuminated object 902 to form a reference beam. Illuminated object 902 may be a patterning device (e.g., mask MA) or any other object subject to inspection by a microscope, of which the holographic measurement device 900 may be a part. The light propagating through a central part of the pupil of an imaging lens 904 is used for forming the reference beam. Imaging lens 904 may include four doublet lenses 906, 908, 910, and 912, for example. As will be understood by the skilled artisan, more or fewer lenses, and of other types, may be used to similar effect. For example, 0^{th} order light propagating through a central part of a pupil plane 914 of imaging lens 904 is used. This is possible because the optical information of the object 902 under investigation, especially the optical information associated with fine and mid-sized features of the object 902, is concentrated in the outer part of the pupil plane 914 of imaging lens 904.

Holographic measurement device 900 may also include a reference beam forming lens group 916. For example, in this embodiment the reference beam forming lens group 916 includes lenses 918 and 922, with the lens 918 situated before a tube lens 924 and the lens 922 situated after the tube lens 924. As will be understood by the skilled artisan, more or fewer lenses, and of other types, may be used to similar effect. As a result of the lens placement, the reference beam 952 is convergent as it passes through the tube lens 924, resulting in a convergent plane wave pattern. Holographic measurement device 900 may also include a spatial filter 920, whose operation is as described above regarding the other figures.

Once the reference beam 952 has passed through the tube lens 924 and the lens 922, a first mirror 926 is set in the optical path of the reference beam 952 at an incline. The first mirror 926 is inclined such that the reference beam 952 is directed to a second mirror 928. The second mirror 928 is inclined such that the reference beam 952 is again directed at the image plane 930. As will be recognized by the skilled artisan, the two inclined mirrors 926 and 928 are by way of example only. More could also be used, or other in the alternative could be prisms instead of mirrors to achieve the same effects. By placing the reference beam 952 at such an angle, a carrier wave is created at a frequency slightly different from the frequency of the object beam 950. When the reference beam 952 is combined with the object beam 950 at the image plane 930, a beating is created which represents the difference between the optical frequencies of the object beam 950 and reference beam 952. Phase plates are not necessary in this embodiment because the use of the mirrors imparts the necessary phase difference to cause an interference pattern at the image plane 930.

Both beams—object beam 950 and reference beam 952—propagate along the main axis of the holographic measurement device 900 through the tube lens 924. Only near the image plane 930 is the reference beam 952 diverted from the shared optical path with the object beam 950 by the inclined mirrors 926 and 928. In this manner, relative displacement or vibration of the object beam and reference beam are substantially eliminated because each beam traverses a shared optical path up until the reference beam 952 is incident upon the first mirror 926, near the image plane 930.

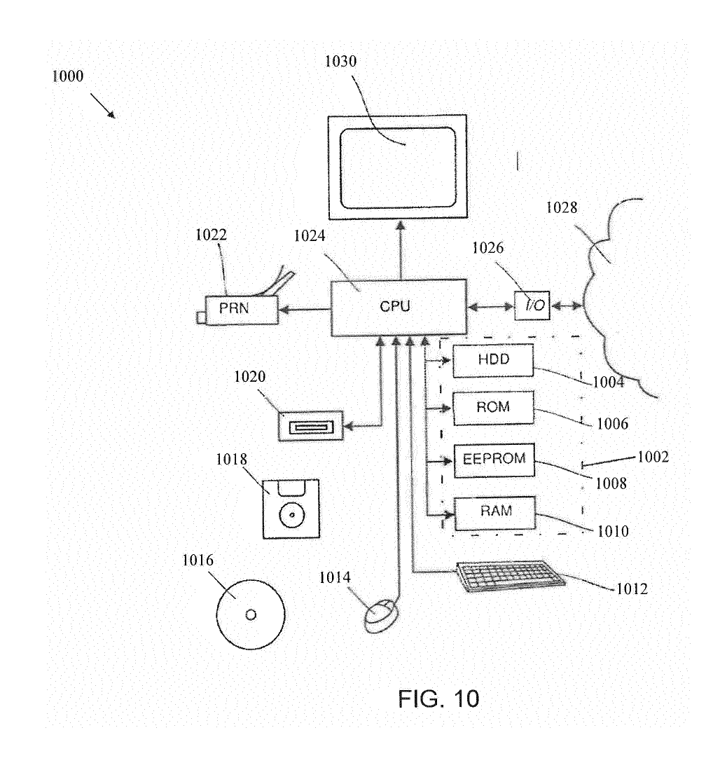

FIG. 10 illustrates computer system hardware useful in implementing the embodiments discussed in FIGS. 3 through 9. In particular, FIG. 10 illustrates a computer assembly useful as a processor configured to reconstruct a recorded pattern on an image plane and determine the interference pattern. The computer assembly may be a dedicated computer in the form of a control unit in embodiments of the assembly according to the invention or, alternatively, be a central computer controlling the lithographic projection apparatus. The computer assembly may be arranged for loading a computer program product comprising computer executable code.

A memory 1002 connected to a processor 1024 may comprise a number of memory components like a hard disk drive (HDD) 1004, Read Only Memory (ROM) 1006, Electrically Erasable Programmable Read Only Memory (EEPROM) 1008 and Random Access Memory (RAM) 1010. Not all aforementioned memory components need to be present. Furthermore, it is not essential that aforementioned memory components are physically in close proximity to the processor 1024 or to each other. They may be located at a distance away from each other.

The processor 1024 may also be connected to some kind of user interface, for instance a keyboard 1012 or a mouse 1014. A touch screen, track ball, speech converter or other interfaces that are known to persons skilled in the art may also be used.

The processor 1024 may be connected to a reading unit 1020, which is arranged to read data, e.g. in the form of computer executable code, from and under some circumstances store data on a data carrier, like a floppy disc 1018 or an optical disk drive 1016. DVDs, flash memory, or other data carriers known to persons skilled in the art may also be used.

The processor 1024 may also be connected to a printer 1022 to print out output data on paper as well as to a display 1030, for instance a monitor or LCD (Liquid Crystal Display), of any other type of display known to a person skilled in the art.

The processor 1024 may be connected to a communications network 1028, for instance a public switched telephone network (PSTN), a local area network (LAN), a wide area network (WAN) etc. by means of transmitters/receivers 1026 responsible for input/output (I/O). The processor 1024 may be arranged to communicate with other communication systems via the communications network 1028. In an embodiment of the invention external computers (not shown), for instance personal computers of operators, can log into the processor 1024 via the communications network 1028.

The processor 1024 may be implemented as an independent system or as a number of processing units that operate in parallel, wherein each processing unit is arranged to execute sub-tasks of a larger program. The processing units may also be divided in one or more main processing units with several sub-processing units. Some processing units of the processor 1024 may even be located a distance away of the other processing units and communicate via communications network 1028. Connections between modules can be made wired or wireless.

The computer system can be any signal processing system with analogue and/or digital and/or software technology arranged to perform the functions discussed here.

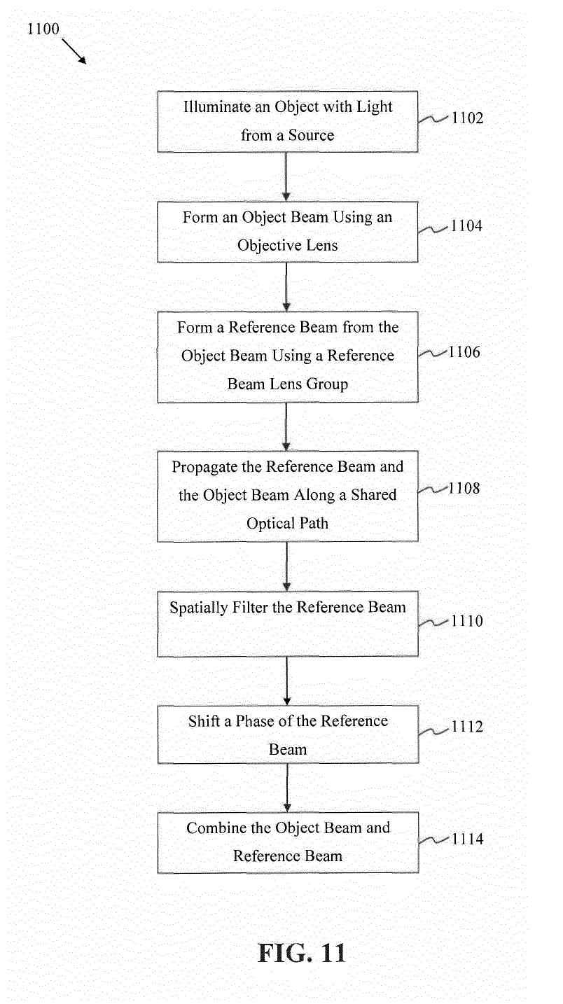

FIG. 11 is a flow diagram of a method 1100 of sharing an optical path to eliminate errors due to vibration, according to embodiments of the present invention. The method begins at step 1102, where an object is illuminated with light from a light source. The light source may be, for example, a broadband light source.

In step 1104, an object beam is formed by an objective lens from light that has been scattered by the illuminated object. The objective lens is configured to direct the object beam through a tube lens, for example a tube lens that is set on the same main optical axis of a holographic device as the objective lens.

In step 1106, a reference beam is formed from the object beam as it exits the objective lens by a reference beam lens group. In one example, the reference beam is formed from the central part of a pupil plane of the objective lens, using 0^{th} order light of the object beam.

In one example, the reference beam lens group is arranged so that the reference beam is divergent as it passes through the tube lens, resulting in a divergent spherical wave pattern on the image plane. In another example, the reference beam lens group is arranged so that the reference beam is convergent as it passes through the tube lens, resulting in a convergent plane wave pattern on the image plane. In a further example, the reference beam and the object beam are each circularly polarized so that they are orthogonally polarized to each other, one having a right-handed circularly polarized beam and the other a left-handed circularly polarized beam.

In step 1108, the object beam and the reference beam are propagated along a shared optical path to an image plane. As indicated above, this configuration eliminates relative displacement or vibration of the object beam and reference beam.

In one example, the object beam and the reference beam are propagated along the shared optical path until both are combined at the image plane. In another example, the object beam and the reference beam share an optical path until just before the image plane, where a set of inclined mirrors divert the reference beam from its path and then recombine the diverted reference beam at the image plane.

In step 1110, the reference beam is spatially filtered to remove from the reference beam any structure of the object beam that may have been intercepted from the central part of the light scattered by the illuminated object, such as rings and side lobes of the light.

In step 1112, a phase of the reference beam is shifted as it traverses the shared optical path. In one example, one or more phase plates are placed along the optical path before the tube lens. In another example, the one or more phase plates are placed after the tube lens. In another example that utilizes the set of inclined mirrors, no phase plates are necessary since the phase shifts are imparted by the use of mirrors. In another example, no phase plates are necessary because there is a pixelated phase mask next to the image plane that has individual phase plates associated with each pixel.

In step 1114, the object beam and the reference beam are combined at the image plane. In one example, the object beam and the reference beam combine where the divergent, spherical wave reference beam overlaps the object beam. In another example, the object beam and the reference beam combine at the center of the image plane where the convergent, plane wave reference beam overlaps the object beam. In another example, the object beam and the reference beam combine across the image plane to create a beating, which represents the difference between the optical frequencies of the object beam and reference beam.

Once the object beam and the reference beam are combined, an interference pattern is created which may then be recorded at the image plane using a detector, e.g., a CCD, or any other suitable imaging device. The recorded pattern may then be reconstructed using a processor.

Although specific reference may be made in this text to the use of methods and apparatus in the manufacture of ICs, it should be understood that the inspection methods and apparatus described herein may have other applications, such as the manufacture of integrated optical systems, guidance and detection patterns for magnetic domain memories, flat-panel displays, liquid-crystal displays (LCDs), thin film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the present invention in the context of optical lithography, it will be appreciated that the present invention may be used in other applications, for example imprint lithography, and where the context allows, is not limited to optical lithography. In imprint lithography, a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm).

The term “lens,” where the context allows, may refer to any one or combination of various types of optical components, including refractive, reflective, magnetic, electromagnetic and electrostatic optical components.

While specific embodiments of the present invention have been described above, it will be appreciated that the present invention may be practiced otherwise than as described. For example, the present invention may take the form of a computer program containing one or more sequences of machine-readable instructions describing a method as disclosed above, or a data storage medium (e.g., semiconductor memory, magnetic or optical disk) having such a computer program stored therein.

The descriptions above are intended to be illustrative, not limiting. Thus, it will be apparent to one skilled in the art that modifications may be made to the present invention as described without departing from the scope of the claims set out below.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the present invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A method comprising:
illuminating an object with a light beam;
forming an object beam using an objective lens that is configured to direct the object beam through a tube lens onto an image plane;
forming a reference beam, from a portion of the object beam passing through a pupil plane of the objective lens, using a reference beam lens group that is configured to propagate the reference beam along a shared optical path with the object beam; and
combining the reference beam and the object beam to create an interference pattern at the image plane.

2. The method of claim 1, further comprising shifting a phase of the reference beam using a phase plate.

3. The method of claim 2, further comprising conditioning the reference beam to generate a spherical wave, such that the reference beam one of diverges to interfere with the object beam at the image plane or converges to interfere with the object beam at the image plane.

4. (canceled)

5. The method of claim 1, further comprising:
diverting the reference beam away from the shared optical path using a first inclined mirror, the first inclined mirror being configured to direct the reflected reference beam to a second inclined mirror; and
redirecting the reference beam to the image plane using the second inclined mirror to create the interference pattern with the object beam.

6. The method of claim 1, further comprising circularly polarizing the reference beam and the object beam with left and right hand polarizers, and wherein the image plane comprises a pixelated phase mask.

7. The method of claim 1, further comprising spatially filtering the reference beam using a spatial filter, the spatial filter positioned at a waist of the reference beam.

8. The method of claim 1, wherein the shared optical path comprises a main axis of an optical system.

9. The method of claim 1, wherein the reference beam is formed using a central portion of the object beam.

10. An inspection apparatus comprising:
a light source configured to produce a light beam;
an objective lens configured to direct an object beam from an object illuminated by the light beam;
a reference beam lens group configured to form a reference beam from a portion of the object beam passing through a pupil plane of the objective lens, the reference beam being propagated along a shared optical path with the object beam;
a tube lens configured to direct the object beam and the reference beam onto an image plane; and
a processor configured to determine an interference pattern on the image plane from the object beam and the reference beam.

11. The inspection apparatus of claim 10, further comprising a phase plate configured to shift a phase of the reference beam.

12. The inspection apparatus of claim 11, wherein the reference beam lens group is configured to condition the reference beam into one of a spherical wave, such that the reference beam diverges to interfere with the object beam at the image plane, or into a plane wave, such that the reference beam converges to interfere with the object beam at the image plane.

13. (canceled)

14. The inspection apparatus of claim 10, further comprising:
a first inclined mirror and/or prism configured to divert the reference beam away from the shared optical path to a second inclined mirror;
wherein the second inclined mirror and/or prism is configured to redirect the reference beam to the image plane to create the interference pattern with the object beam.

15. The inspection apparatus of claim 10, further comprising:
a right hand polarizer; and
a left hand polarizer;
wherein the right hand polarizer and the left hand polarizer are configured to circularly polarize the reference beam and the object beam, and
wherein the image plane comprises a pixelated phase mask.

16. The inspection apparatus of claim 10, further comprising a spatial filter configured to spatially filter the reference beam, the spatial filter positioned at a waist of the reference beam.

17. The inspection apparatus of claim 10, wherein:
the reference beam is formed using a portion of the object beam that passes through a central part of the pupil plane of the objective lens, and
the shared optical path comprises a main axis of an optical system.

18. In an optical system, a method comprising:
illuminating an object with a light beam;
forming an object beam using a microscope lens arrangement that is configured to direct the object beam through a tube lens onto an image plane along a main axis of the optical system;
forming a reference beam using a reference beam lens group that is positioned at a central portion of a pupil plane of the microscope lens arrangement along the main axis of the optical system, wherein the reference beam is formed from a portion of the object beam passing through the pupil plane of the microscope lens arrangement;
propagating the reference beam along a shared optical path with the object beam;
shifting a phase of the reference beam using a phase plate; and
combining the reference beam and the object beam to create an interference pattern at the image plane.

19. The method of claim 18, further comprising conditioning the reference beam to generate one of a spherical wave, such that the reference beam diverges to interfere with the object beam at the image plan, or a plane wave, such that the reference beam converges to interfere with the object beam at the image plane.

20. (canceled)

21. A method for microscopy, the method comprising:
propagating an object beam, formed from light scattered by an illuminated object, along an optical path and a longitudinal axis of an optical arrangement;
propagating a reference beam, formed from a portion of the scattered light, along the optical path substantially simultaneously with the object beam; and
interfering the reference beam with the object beam at an image plane to create a hologram image.

22. A method for microscopy, the method comprising:
providing a first optical arrangement having a longitudinal axis to propagate an object beam, the object beam formed from light scattered by an illuminated object, in an optical path along the longitudinal axis; and
integrating a second optical arrangement with the first optical arrangement to propagate a reference beam, the reference beam formed from a portion of the light scattered by the illuminated object, substantially simultaneously with the object beam in the optical path along the longitudinal axis for causing interference with the object beam at an image plane.

23. The method of claim 22, further comprising:
generating a hologram image by interfering the reference beam with the object beam at the image plane; and
detecting the hologram image to inspect the illuminated object for determining one or more properties of the illuminated object.

24. (canceled)
